(19) United States
(12) Patent Application Publication
(10) Pub. No.: US 2006/0049181 A1
(43) Pub. Date: Mar. 9, 2006

(54) Perfectfit system for leather shoes

(76) Inventors: Vaike Tuhkru, Calgary (CA); Alexander Tretjakov, Calgary (CA)

Correspondence Address: Vaike Tuhkru;Alexander Tretjakov, Suite 405, 420, 3rd St. NE., Calgary, AB, T2E 7W5, CA

(21) Appl. No.: 10/930,030

(22) Filed: Aug. 31, 2004

(51) Int. Cl. H05B 6/64

(52) U.S. Cl. 219/678

(57) ABSTRACT

PerfectFit System utilizes the notion that when heated leather becomes softer and more elastic. It also uses a unique method of achieving that, by taking two heating bags filled with sea salt (or any other microwave-safe substance), and heating them in the microwave for several minutes. After which inserting them into the shoes to heat them up, and make the leather more supple. The process is completed by cooling the heated shoes on the foot. The heated leather forms to the shape of the foot, as it cools down. This makes the shoes very comfortable to wear.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

Class 12 “Boot and shoe making” refers to machines and processes involved in the production and repair of shoes. This pertains directly to our invention, as the process of fitting leather shoes involves heating of the leather with a hand manipulable device as described in the subclass 128.

### BRIEF SUMMARY OF THE INVENTION

With a help of a kit that contains two heating bags, one microwave proof plastic container, and a heat conservation bag. We are able to brake-in leather shoes within 20 minutes required for the PerfectFit System to work. Following which shoes become softer and fit very comfortably on the foot.

### BRIEF DESCRIPTION OF THE SEVERAL VIEWS OF THE DRAWING

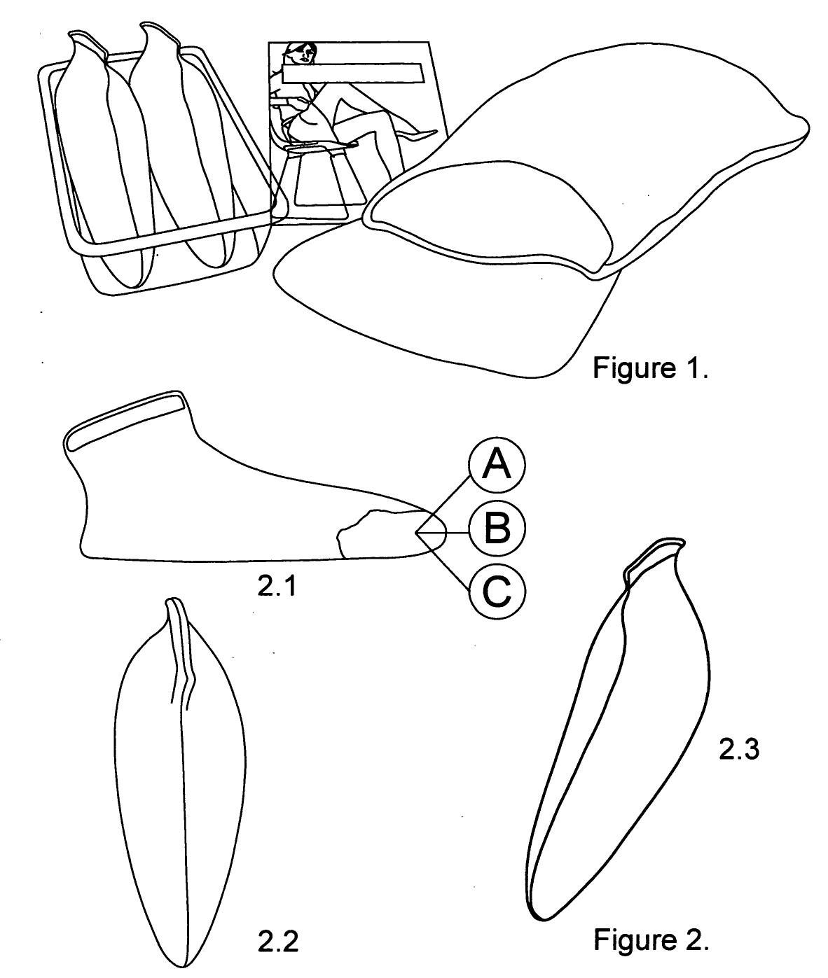

FIG. 1. The contents of the PerfectFit System kit in a perspective view:
Two heating bags
Microwave-safe plastic container
Manual
Heat conservation bag

FIG. 2. Different views of the heating bag. Structure and contents
2.1 Side view of the bag with a dissection to indicate possible fillers:
   A. Large grain sea salt
   B. Large grain sand
   C. Finely grinded gravel.
2.2 Top view of the heating bag.
2.3 Perspective view of the bag.

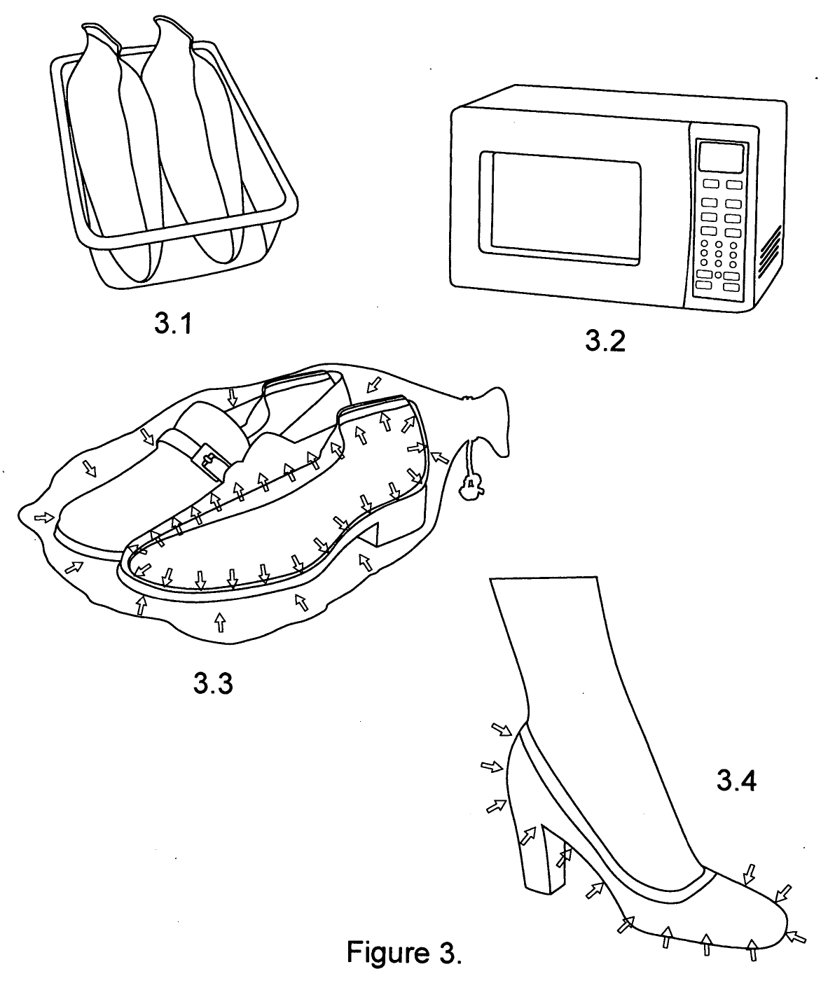

FIG. 3. Demonstration of the PerfectFit System at work.
3.1 Put the heating bags in the microwave-safe container
3.2 Heat the bags in the microwave for 10 minuts
3.3 Place the heated bags inside the shoes and put the shoes in the heat conservation bag
3.4 Put the shoes on and let them cool down on the foot.

### DETAILED DESCRIPTION OF THE INVENTION

The PerfectFit System kit contains: two heating bags, one microwave proof plastic container, and a heat conservation bag. The two bags are filled with sea salt, small grinded gravel, or any other material that can be heated in the microwave and retain heat. They are made from a denim-like fabric, that is dense enough not to let the filling of the bag, pass through the surface, as well as being able to withstand heating in the microwave. The heat conservation bag is made from wool or any other heat conservation fabric, on the inside, and any decorative fabric on the outside. In order to be able to brake-in leather shoes, we are going to heat the two bags in the microwave for 10 minutes. Following which we will place the bags inside the leather shoes that we are braking-in, and put the shoes, with the heating bags inside, into the heat-conservation bag for another 10 minutes. By putting the shoes on and letting them cool down, the heated and elastic leather takes the form of the foot, to result in a perfectly fitting shoe.

1. We claim as our invention the following process:
In the process of braking-in leather shoes—using heat in order to make leather, in shoes, soft and elastic, following by wearing the shoes while they cool down and the leather takes form of the foot, to result in a comfortably fitting shoe.

2. We claim as our invention the following kit used in the process of claim 1:
Two heating bags filled with any heat able material that is microwave safe and capable of retaining heat (some of the options can be: sea salt, sand or finely grinded gravel) Made from denim like dense fabric, that will not allow the contents of the bag to spill and is microwave safe.
One plastic microwave safe container.
One heat conservation bag, made from an insulation fabric on the inside and decorative one on the outside.

3. We claim as our invention use of the kit from the claim number 2 in the following process:
Place the heating bags into the plastic microwave safe container.
Heat the bags in the microwave for 5-15 minutes.
Place the heating bags into the shoes and place the shoes inside the heat conservation bag. Leave for 10 or more minutes
Put the shoes on, and let them cool down on your foot while you wear them. To result in comfortable fitting shoes.
